(19) United States
(12) Patent Application Publication
(10) Pub. No.: US 2024/0223780 A1
(43) Pub. Date: Jul. 4, 2024

(54) GENERATING TILE-BASED REGION OF INTEREST REPRESENTATION OF VIDEO FRAMES FOR VIDEO ENCODING

(71) Applicant: META PLATFORMS TECHNOLOGIES, LLC, Menlo Park, CA (US)

(72) Inventors: Nayeong KIM, Berkeley, CA (US); Chun-Wei CHAN, Foster City, CA (US)

(21) Appl. No.: 18/150,103

(22) Filed: Jan. 4, 2023

(51) Int. Cl. H04N 19/167; G06T 7/11; H04N 19/176

(52) U.S. Cl. CPC H04N 19/167; G06T 7/11; H04N 19/176

(57) ABSTRACT

One embodiment of the present invention sets forth a technique for generation region-based user interest levels for use during video encoding. The technique includes identifying a plurality of view events associated with a frame of a video content, wherein each view event comprises field of view information indicating a region in the frame at which an interest of a given user was directed when the frame was being rendered, processing the field of view information included in at least a subset of the plurality of view events to generate per-pixel interest levels for a plurality of pixels in the frame, determining a plurality of regions in the frame including the plurality of pixels, generating per-region interest levels for the plurality of regions based on the per-pixel interest levels, and transmitting the per-region interest levels to one or more encoders for encoding the video content in a manner that accounts for the plurality of view events.

### BACKGROUND

### Field of the Various Embodiments

Embodiments of the present disclosure relate generally to machine learning and image editing and, more specifically, to generating tile-based region of interest representation of video frames for video encoding.

### DESCRIPTION OF THE RELATED ART

Video encoding is a mechanism by which raw video content is transformed into a format that is often more compressed in size and can be played by variety of devices. Some video encoders account for the downstream application or user interests when encoding a raw video. For example, certain spatial and temporal regions or objects in the video may be of more interest/importance than other areas, and the video encoder encodes these regions with higher fidelity relative to other regions.

One complexity that arises with interest-based encoding is the sheer volume of interest information that is associated with a given video. Providing this large volume of interest information to the encoder is a bandwidth and storage intensive process. Further, the encoding efficiency of the encoder deteriorates when processing the large volume of interest information. Therefore, even though encoding videos using the interest-information is preferable, the computational and storage burden that accompanies such a process is often prohibitive to implement.

As the foregoing illustrates, what is needed in the art are more effective techniques for performing interest-based video encoding.

### SUMMARY

One embodiment of the present invention sets forth a technique for generation region-based user interest levels for use during video encoding. The technique includes identifying a plurality of view events associated with a frame of a video content, wherein each view event comprises field of view information indicating a region in the frame at which an interest of a given user was directed when the frame was being rendered, processing the field of view information included in at least a subset of the plurality of view events to generate per-pixel interest levels for a plurality of pixels in the frame, determining a plurality of regions in the frame including the plurality of pixels, generating per-region interest levels for the plurality of regions based on the per-pixel interest levels, and transmitting the per-region interest levels to one or more encoders for encoding the video content in a manner that accounts for the plurality of view events.

One technical advantage of the disclosed techniques relative to the prior art is that the region-based interest level representation is a compressed representation of raw interest information associated with video content, enabling more efficient storage, transmission, and processing of the interest information. In particular, a downstream encoder receiving the region-based interest level can process and use the interest information during the encoding process much more efficiently relative to the raw interest information. Thus, using the region-based interest level representation enables encoders to more readily utilize interest-based encoding, thereby improving the performance of the encoding process and also of downstream delivery and consumption of the encoded videos. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a system configured to implement one or more aspects of various embodiments.

FIG. 2 is an interaction diagram illustrating the operation of the systems of FIG. 1 when generating a region-based representation of regions of interest in a video, according to various embodiments.

FIG. 3 is a flow diagram of method steps for generating a region-based representation of interest in video frames, according to various embodiments.

FIG. 4 is a block diagram of an embodiment of a near-eye display (NED) system in which a console operates, according to various embodiments.

FIG. 5A is a diagram of an NED, according to various embodiments.

FIG. 5B is another diagram of an NED, according to various embodiments.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

### SYSTEM OVERVIEW

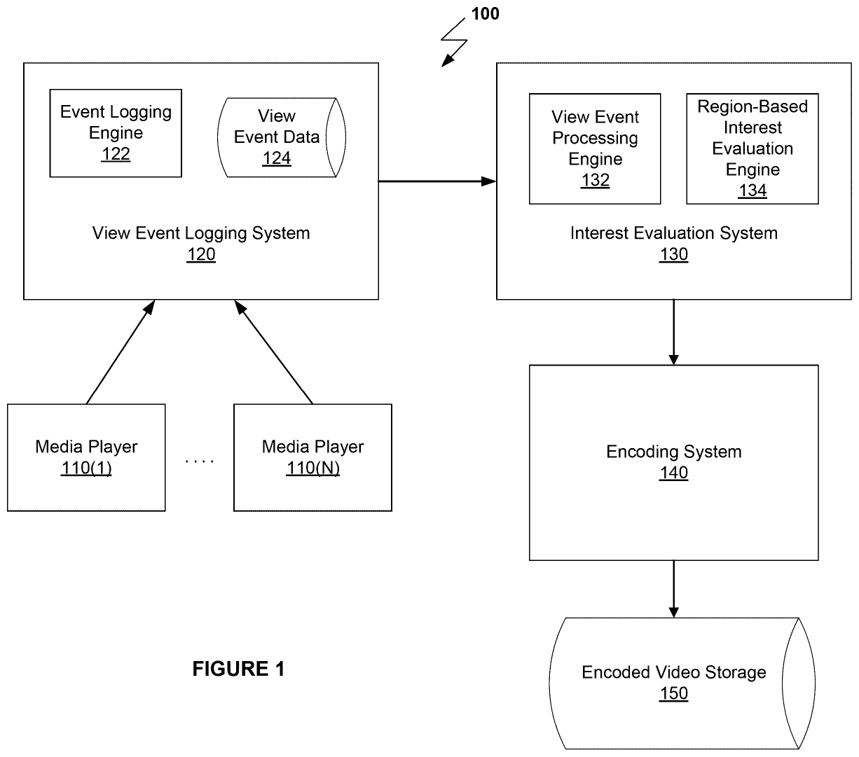

FIG. 1 illustrates a system 100 configured to implement one or more aspects of various embodiments. In one embodiment, the system 100 includes one or more media players 110(1)-(N) (collectively referred to as media players 110 and individually referred to as a media player 110), a view event logging system 120, an interest evaluation system 130, an encoding system 140, and an encoded video storage 150. It is noted that the system described herein is illustrative and that any other technically feasible configurations fall within the scope of the present disclosure. For example, multiple instances of the view event logging system 120, the interest evaluation system 130, and the encoding system 140 could execute on a set of nodes in a distributed system to implement the respective functionalities of the systems. Furthermore, the encoded video storage 150 could be a distributed storage system, such as a content delivery network or other video storage and delivery platform.

In various embodiments, the view event logging system 120, the media players 110, the interest evaluation system, the encoding system 140, and the encoded video storage 150 can comprise one or more computing devices. The computing device may be a desktop computer, a laptop computer, a smart phone, a personal digital assistant (PDA), a tablet computer, a server, or any other type of computing device configured to receive input, process data, and optionally display images, and is suitable for practicing one or more embodiments.

In one embodiment, a computing device includes, without limitation, an interconnect (bus) that connects one or more processors, an input/output (I/O) device interface coupled to one or more input/output (I/O) devices, a memory, a storage, and a network interface. The processor(s) may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) may be any technically feasible hardware unit capable of processing data and/or executing software applications. Further, in the context of this disclosure, the computing elements in the computing device may correspond to a physical computing system (e.g., a system in a data center) or may be a virtual computing instance executing within a computing cloud.

The I/O devices include devices capable of providing input, such as a keyboard, a mouse, a touch-sensitive screen, and so forth, as well as devices capable of providing output, such as a display device. Additionally, the I/O devices may include devices capable of both receiving input and providing output, such as a touchscreen, a universal serial bus (USB) port, and so forth. The I/O devices may be configured to receive various types of input from an end-user (e.g., a designer) of the computing device, and to also provide various types of output to the end-user of computing device, such as displayed digital images or digital videos or text. In some embodiments, one or more of I/O devices are configured to couple computing device to a network.

The network can be any technically feasible type of communications network that allows data to be exchanged between the computing device and external entities or devices, such as a web server or another networked computing device. For example, the network may include a wide area network (WAN), a local area network (LAN), a wireless (WiFi) network, and/or the Internet, among others.

The storage includes non-volatile storage for applications and data, and may include fixed or removable disk drives, flash memory devices, and CD-ROM, DVD-ROM, Blu-Ray, HD-DVD, or other magnetic, optical, or solid state storage devices. The memory includes a random access memory (RAM) module, a flash memory unit, or any other type of memory unit or combination thereof. The processor(s), I/O device interface, and network interface are configured to read data from and write data to the memory. The memory includes various software programs that can be executed by the processor(s) and application data associated with said software programs.

### Generating Per-Region Interest Levels

In operation, the view event logging system 120 receives and stores view events for various media players 110. A view event occurs when a field of view associated with a video being consumed via a media player 110 is modified. In various embodiments, the view event identifies one or more of the video being consumed, the media player 110 on which the video is being consumed, the view angle of the scene being viewed within the video, and frame information associated with the current frame being consumed. The view event logging system 120 logs the view events received from the various media players 110. When a threshold amount of view events for a given video are received, the view event logging system 120 transmits a notification to the interest evaluation system 130. The interest evaluation system 130 processes the view events associated with a given video to generate a heatmap for each frame of the video. The heatmap indicates, for a given frame, regions of interest in that frame as determined based on users' view angles. For a given frame, the interest evaluation system 130 divides the frame into tiles and, for each tile, determines a corresponding interest level based on the region in the heatmap that corresponds to the tile. The interest evaluation system 130 aggregates the interest levels for each frame into a region-based interest level representation associated with the video. The encoding system 140 generates a new encoded version of the video using the region-based interest level representation associated with the video. The new encoded version of the video can be transmitted to media players 110 in order to improve the viewing experience of the video. The following description provides additional details regarding the operation of the components of system 100.

Media players 110 are instances of video playing software operated by users. A media player 110 can be an immersive video playing system, such as a virtual reality system, a web-based media player, such as a media player embedded on a website, media player software executing on a set-top box, or any other type of software that enables a user to access media content. When a user interacts with a video being played via a media player 110, the media player 110 transmits a view event to the view event logging system 120 via a communications network (not shown). Such an interaction includes, but is not limited to, starting a video or modifying the viewport (i.e., the user's visible area within the video) of a currently playing video. In various embodiments, the media player 110 includes an event listener software component that is triggered when a user interacts with a video. The event listener generates a view event that is transmitted to the view event logging system 120.

The view event transmitted by the media player 110 includes a player identification associated with the media player 110, a content identification associated with the video being played, a frame identification, e.g., a timestamp, associated with the current frame being played, and the current view angle associated with the viewport. The view angle identifies the current field of view of a video frame from a given viewpoint, such as a given camera location. In the case of immersive videos, the video frame may be represented in three-dimensional space using a spherical coordinate system. Under this representation, the view angle is the angle from the center of the spherical coordinate system to the point on the surface of the sphere where the user is viewing the immersive video.

The view event logging system 120 comprises one or more computing devices that execute instructions associated with the event logging engine 122 and the view event data store 124. The event logging engine 122 receives view events from media players 110 and stores the view events in the view event data store 124. The event logging engine 122 monitors the view events stored in the view event data store 124 for each video. When the number of view events for a given video exceed a pre-identified threshold, the event logging engine 122 transmits a notification to the interest evaluation system 130 to process the view events for that video. The threshold indicates a certain number of view events needed to determine which regions in the video are of interest to users. The threshold for a given video can be based on the complexity of the video, the length of the video, the genre of the video, the target audience for the video, the downstream encoding process to be used for encoding the video, or any other characteristics associated with the video, the audience, or the system 100. In one embodiment, the threshold associated with a given video changes over time. For example, when view events associated with the video are being processed for the first time, the threshold may be lower to make a coarse determination of which regions in the video are of interest to users. Subsequently, the threshold may increase in order to process view events when enough events are available to fine-tune the coarse determination. As another example, for videos gaining popularity, the threshold may increase as the popularity of the video increases.

As discussed above, when the number of view events for a given video exceed a pre-identified threshold, the event logging engine 122 transmits a notification to the interest evaluation system 130 to process the view events for that video. In response, the view event processing engine 132 in the interest evaluation system 130 retrieves the view events associated with the video. The view event processing engine 132 processes the view events to generate a per-pixel interest level data structure for each frame of the video. For each pixel in each frame, the view event processing engine 132 determines a number of corresponding view events that include a viewing angle encompassing the pixel. The view event processing engine 132 generates a per-pixel data structure that specifies, for each pixel in a frame, a user interest level based on the determined number of corresponding view events.

In one embodiment, the per-pixel data structure for a frame of the given video is a heatmap for each frame of the video. The heatmap indicates, for a given frame, regions of pixels in that frame, as determined based on users' view angles, having different interest levels. More specifically, for a given frame, the heatmap indicates regions of pixels in the frame where the users' interest was directed. For a given region, the heatmap could show different colors associated with the concentration of user interest. In other embodiments, the per-pixel data structure could be a tabular data structure, a hash map, or any other data format that indicates an amount of user interest for each pixel of the frame.

Once the per-pixel data structures for frames of the video are generated, the region-based interest evaluation engine 134 generates a per-region data structure for each frame of the video. The per-region data structure specifies, for each region in the frame, a user interest level based on the per-pixel data structure. In operation, the region-based interest evaluation engine 134 divides a given frame of the video into different regions, e.g., tiles. In various embodiments, different frames in a given video may be divided into the same number of regions or different number of regions depending on frame complexity. For each region, the region-based interest evaluation engine 134 processes the per-pixel interest level included in the per-pixel data structure associated with the frame and associated with pixels in that region to generate a per-region interest level. In various embodiments, the region-based interest evaluation engine 134 could average the per-pixel interest levels associated with pixels in that region to generate a per-region interest level. Other techniques for aggregating the per-pixel interest levels associated with pixels in that region are within the scope are within the scope of this disclosure.

The region-based interest evaluation engine 134 collates the per-region interest levels for the different regions (or tiles, portions, etc.) in the frame to generate the per-region data structure for the frame. In such a manner, the region-based interest evaluation engine 134 generates a per-region data structure for each frame of the video. In various embodiments, the per-region data structure for a frame is much smaller in size than the per-pixel data structure for that frame. In such a manner, representing the interest level information in the per-region data structure enables the region-based interest evaluation engine 134 to generate a much more compact version of the interest level information that is easier to transmit and process by downstream components of the system.

In one embodiment, the per-region data structure has a following format: “{[timestamp]: [vector of interesting level]}.” The “[timestamp]” indicates a timestamp associated with a frame and the “[vector of interesting level]” indicates a vector of per-region interest levels, where the position of each per-region interest level indicates the region in the frame that corresponds to the interest level. For example, assuming a video with three frames at timestamps 0.0, 0:10.2, and 1:20.0, respectively. The region-based interest evaluation engine 134 divides each of the three frames into thirty-two equal sized regions and generates the per-region data structure for each frame. In such an example, the output of the region-based interest evaluation engine 134 for the three frames could be the following: {0.0:[8, 8, 6, 6, 4, 4, 4, 2, 2, 2, 0, 0, 0, 0, 2, 2, 2, 4, 4, 4, 6, 4, 4, 2, 2, 2, 2, 4, 4, 2, 2, 6], 0:10.2:[8, 8, 6, 6, 4, 4, 4, 2, 2, 2, 0, 0, 0, 0, 2, 2, 2, 4, 4, 4, 6, 4, 4, 2, 2, 2, 2, 4, 4, 2, 2, 6], 1:20.0:[8, 8, 6, 6, 4, 4, 4, 2, 2, 2, 0, 0, 0, 0, 2, 2, 2, 4, 4, 4, 6, 4, 4, 2, 2, 2, 2, 4, 4, 2, 2, 6] . . . }.

When the per-region data structures associated with at least some of the frames of the video are generated, the region-based interest evaluation engine 134 transmits the per-region data structures to the encoding system 140. The encoding system 140 encodes the video to generate a new encoded version of the video based on the per-region data structures. In various embodiments, the encoding algorithm used by the encoding system 140 accounts for the interest levels of different regions of a frame when encoding a frame, such that regions with higher interest level are encoded at a higher quality or fidelity relative to regions with lower interest levels. The encoding system 140 stores the new encoded version of the video in the encoded video storage 150. The new encoded version of the video, or portions thereof, stored in the encoded video storage 150 can be transmitted, streamed, or otherwise provided to media players 110 when users of those media players 110 request to view the video.

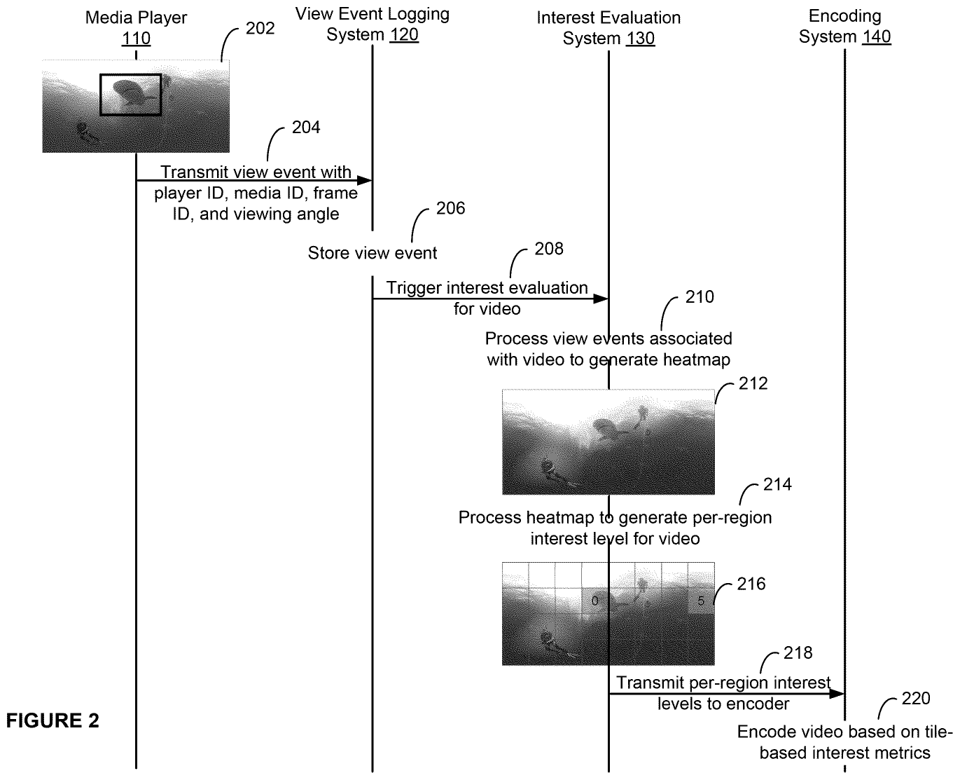

FIG. 2 is an interaction diagram illustrating the operation of the systems of FIG. 1 when generating a tile-based representation of regions of interest in a video, according to various embodiments. As shown, at 202, a media player 110 is playing a video. The video includes multiple objects, including a shark, which is in the current viewing angle of a user viewing the video. At 204, the media player 110 transmits a video event to the view event logging system 120. As discussed above, the view event includes a player identification associated with the media player 110, a content identification associated with the video being played, a frame identification, e.g., a timestamp, associated with the current frame being played, and the current view angle associated with the viewport. At 206, the view event logging system 120 stores the view event received from the media player 110.

At 208, the view event logging system 120 triggers the interest evaluation operations for the video when a threshold number of view events for the video are received by the view event logging system 120. At 210, the interest evaluation system 130 processes the view events to generate a per-pixel interest level data structure, a heatmap, for each frame of the video. The heatmap indicates, for a given frame, regions of pixels in that frame, as determined based on users' view angles, having different interest levels. As shown in the image 212, the heatmap indicates the regions encompassing the shark and divers as being regions of interest.

At 214, the interest evaluation system 130 generates a per-region data structure for each frame of the video. The per-region data structure specifies, for each region in the frame, a user interest level based on the per-pixel data structure. As shown in the image 216, the interest evaluation system 130 divides the frame different regions, e.g., tiles. For each region, the region-based interest evaluation engine 134 processes the per-pixel interest level included in the per-pixel data structure (i.e., the heatmap) to generate a per-region interest level. The per-region interest levels are stored in the per-region data structure. At 218, the interest evaluation system 130 transmits the per-region data structure to the encoding system 240. At 220, the encoding system 140 encodes the video to generate a new encoded version of the video based on the per-region data structures.

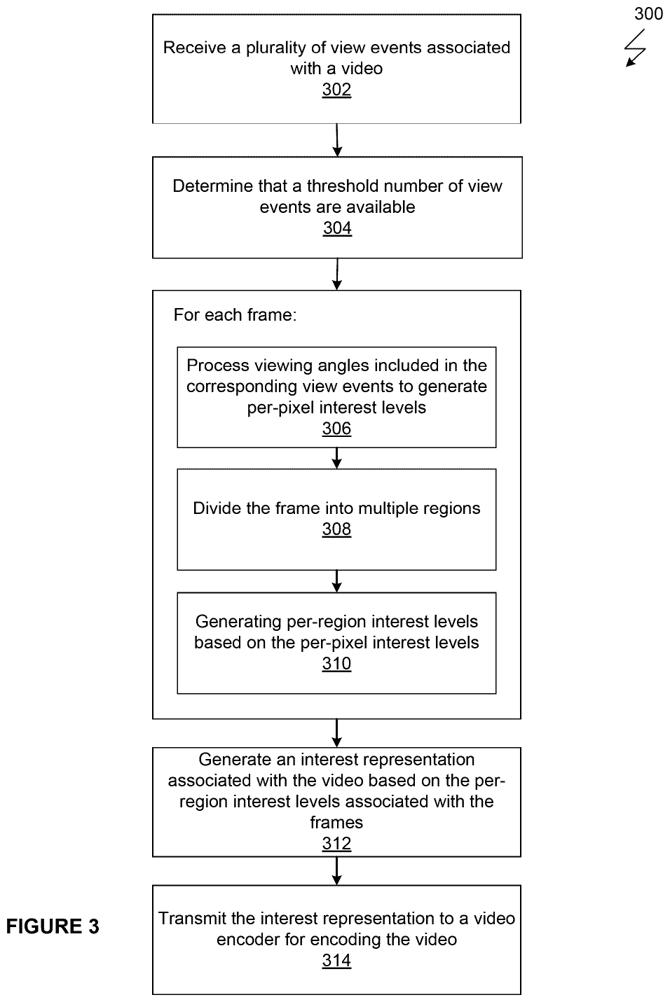

FIG. 3 is a flow diagram of method steps for generating a region-based representation of interest in video frames, according to various embodiments. Although the method steps are described in conjunction with the systems of FIGS. 1-2, persons skilled in the art will understand that any system configured to perform the method steps in any order falls within the scope of the present disclosure.

As shown, in step 302 of flow diagram 300, the view event logging system 120 receives a plurality of view events associated with multiple frames of a video. As discussed above, the view event includes a player identification associated with the media player 110, a content identification associated with the video being played, a frame identification, e.g., a timestamp, associated with the current frame being played, and the current view angle associated with the viewport. At step 304, the view event logging system 120 determines that a threshold number of view events associated with the video are available. The threshold number is a certain number of view events needed to determine which regions in the video are of interest to users.

Steps 306-310 are performed for each frame of the video. At step 306, the interest evaluation system 130 processes the viewing angles included in view events corresponding to the frame to generate per-pixel interest levels. In particular, for each pixel in each frame, the view event processing engine 132 determines a number of corresponding view events that include a viewing angle encompassing the pixel. The view event processing engine 132 generates a per-pixel data structure that specifies, for each pixel in a frame, a user interest level based on the determined number of corresponding view events. At step 308, the interest evaluation system 130 divides the frame into multiple regions. At step 310, the interest evaluation system 130 generates per-region interest levels based on the per-pixel interest levels generated at step 306.

At step 312, once steps 306-310 are completed for all frames, the interest evaluation system 130 generates an interest representation associated with the video that collates the per-region interest levels of all the frames in the video. The interest representation may be in the form: {[frame ID]:[vector of per-region interest levels], [frame ID]:[vector of per-region interest levels], [frame ID]:[vector of per-region interest levels] . . . }. At step 314, the interest evaluation system 130 transmits the interest representation to the video encoder in the encoding system 140. The video encoder encodes the video in a manner that accounts for the different interest levels for different regions of frame, where regions with higher interest levels are encoded to be of higher quality or fidelity relative to regions with lower interest levels.

### Artificial Reality System

Embodiments of the disclosure may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a head-mounted display (HMD) or near-eye display (NED) connected to a host computer system, a standalone HMD or NED, a mobile device or computing system, or any other hardware platform capable of providing artificial reality content to one or more viewers.

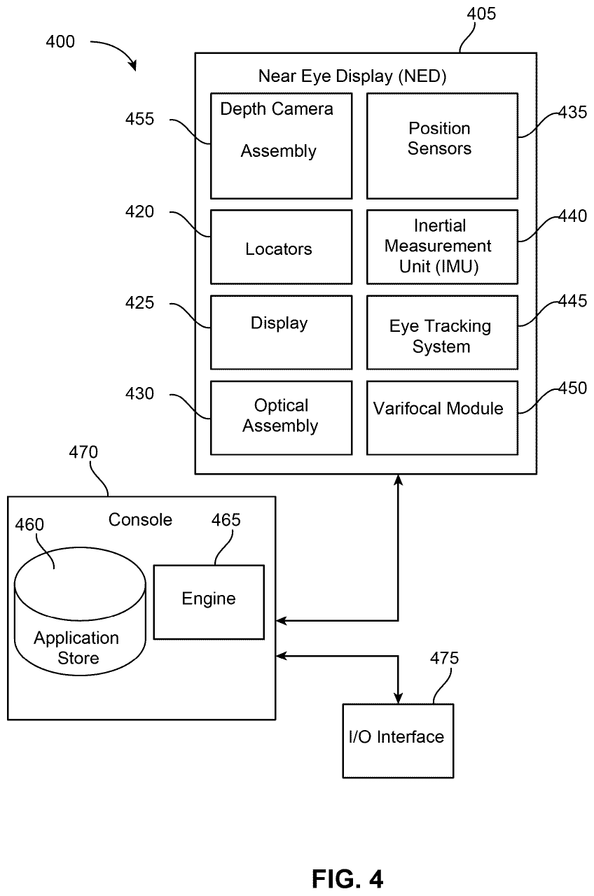

FIG. 4 is a block diagram of an embodiment of a near-eye display (NED) system 400 in which a console operates, according to various embodiments. The NED system 400 may operate in a virtual reality (VR) system environment, an augmented reality (AR) system environment, a mixed reality (MR) system environment, or some combination thereof. The NED system 400 shown in FIG. 4 comprises a NED 405 and an input/output (I/O) interface 455 that is coupled to the console 470.

While FIG. 4 shows an example NED system 400 including one NED 405 and one I/O interface 475, in other embodiments any number of these components may be included in the NED system 400. For example, there may be multiple NEDs 405, and each NED 405 has an associated I/O interface 475. Each NED 405 and I/O interface 475 communicates with the console 470. In alternative configurations, different and/or additional components may be included in the NED system 400. Additionally, various components included within the NED 405, the console 470, and the I/O interface 475 may be distributed in a different manner than is described in conjunction with FIGS. 1-3B in some embodiments. For example, some or all of the functionality of the console 470 may be provided by the NED 405 and vice versa.

The NED 405 may be a head-mounted display that presents content to a user. The content may include virtual and/or augmented views of a physical, real-world environment including computer-generated elements (e.g., two-dimensional or three-dimensional images, two-dimensional or three-dimensional video, sound, etc.). In some embodiments, the NED 405 may also present audio content to a user. The NED 405 and/or the console 470 may transmit the audio content to an external device via the I/O interface 475. The external device may include various forms of speaker systems and/or headphones. In various embodiments, the audio content is synchronized with visual content being displayed by the NED 405.

The NED 405 may comprise one or more rigid bodies, which may be rigidly or non-rigidly coupled together. A rigid coupling between rigid bodies causes the coupled rigid bodies to act as a single rigid entity. In contrast, a non-rigid coupling between rigid bodies allows the rigid bodies to move relative to each other.

As shown in FIG. 4, the NED 405 may include a depth camera assembly (DCA) 455, one or more locators 420, a display 425, an optical assembly 430, one or more position sensors 435, an inertial measurement unit (IMU) 440, an eye tracking system 445, and a varifocal module 450. In some embodiments, the display 425 and the optical assembly 430 can be integrated together into a projection assembly. Various embodiments of the NED 405 may have additional, fewer, or different components than those listed above. Additionally, the functionality of each component may be partially or completely encompassed by the functionality of one or more other components in various embodiments.

The DCA 455 captures sensor data describing depth information of an area surrounding the NED 405. The sensor data may be generated by one or a combination of depth imaging techniques, such as triangulation, structured light imaging, time-of-flight imaging, stereo imaging, laser scan, and so forth. The DCA 455 can compute various depth properties of the area surrounding the NED 405 using the sensor data. Additionally or alternatively, the DCA 455 may transmit the sensor data to the console 470 for processing. Further, in various embodiments, the DCA 455 captures or samples sensor data at different times. For example, the DCA 455 could sample sensor data at different times within a time window to obtain sensor data along a time dimension.

The DCA 455 includes an illumination source, an imaging device, and a controller. The illumination source emits light onto an area surrounding the NED 405. In an embodiment, the emitted light is structured light. The illumination source includes a plurality of emitters that each emits light having certain characteristics (e.g., wavelength, polarization, coherence, temporal behavior, etc.). The characteristics may be the same or different between emitters, and the emitters can be operated simultaneously or individually. In one embodiment, the plurality of emitters could be, e.g., laser diodes (such as edge emitters), inorganic or organic light-emitting diodes (LEDs), a vertical-cavity surface-emitting laser (VCSEL), or some other source. In some embodiments, a single emitter or a plurality of emitters in the illumination source can emit light having a structured light pattern. The imaging device includes camera sensors that capture ambient light in the environment surrounding NED 405, in addition to light reflected off of objects in the environment that is generated by the plurality of emitters. In various embodiments, the imaging device may be an infrared camera or a camera configured to operate in a visible spectrum. The controller coordinates how the illumination source emits light and how the imaging device captures light. For example, the controller may determine a brightness of the emitted light. In some embodiments, the controller also analyzes detected light to detect objects in the environment and position information related to those objects.

The locators 420 are objects located in specific positions on the NED 405 relative to one another and relative to a specific reference point on the NED 405. A locator 420 may be a light emitting diode (LED), a corner cube reflector, a reflective marker, a type of light source that contrasts with an environment in which the NED 405 operates, or some combination thereof. In embodiments where the locators 420 are active (i.e., an LED or other type of light emitting device), the locators 420 may emit light in the visible band (˜340 nm to 550 nm), in the infrared (IR) band (˜550 nm to 5500 nm), in the ultraviolet band (50 nm to 340 nm), some other portion of the electromagnetic spectrum, or some combination thereof.

In some embodiments, the locators 420 are located beneath an outer surface of the NED 405, which is transparent to the wavelengths of light emitted or reflected by the locators 420 or is thin enough not to substantially attenuate the wavelengths of light emitted or reflected by the locators 420. Additionally, in some embodiments, the outer surface or other portions of the NED 405 are opaque in the visible band of wavelengths of light. Thus, the locators 420 may emit light in the IR band under an outer surface that is transparent in the IR band but opaque in the visible band.

The display 425 displays two-dimensional or three-dimensional images to the user in accordance with pixel data received from the console 470 and/or one or more other sources. In various embodiments, the display 425 comprises a single display or multiple displays (e.g., separate displays for each eye of a user). In some embodiments, the display 425 comprises a single or multiple waveguide displays. Light can be coupled into the single or multiple waveguide displays via, e.g., a liquid crystal display (LCD), an organic light emitting diode (OLED) display, an inorganic light emitting diode (ILED) display, an active-matrix organic light-emitting diode (AMOLED) display, a transparent organic light emitting diode (TOLED) display, a laser-based display, one or more waveguides, other types of displays, a scanner, a one-dimensional array, and so forth. In addition, combinations of the display types may be incorporated in display 425 and used separately, in parallel, and/or in combination.

The optical assembly 430 magnifies image light received from the display 425, corrects optical errors associated with the image light, and presents the corrected image light to a user of the NED 405. The optical assembly 430 includes a plurality of optical elements. For example, one or more of the following optical elements may be included in the optical assembly 430: an aperture, a Fresnel lens, a convex lens, a concave lens, a filter, a reflecting surface, or any other suitable optical element that deflects, reflects, refracts, and/or in some way alters image light. Moreover, the optical assembly 430 may include combinations of different optical elements. In some embodiments, one or more of the optical elements in the optical assembly 430 may have one or more coatings, such as partially reflective or antireflective coatings.

In some embodiments, the optical assembly 430 may be designed to correct one or more types of optical errors. Examples of optical errors include barrel or pincushion distortions, longitudinal chromatic aberrations, or transverse chromatic aberrations. Other types of optical errors may further include spherical aberrations, chromatic aberrations or errors due to the lens field curvature, astigmatisms, in addition to other types of optical errors. In some embodiments, visual content transmitted to the display 425 is pre-distorted, and the optical assembly 430 corrects the distortion as image light from the display 425 passes through various optical elements of the optical assembly 430. In some embodiments, optical elements of the optical assembly 430 are integrated into the display 425 as a projection assembly that includes at least one waveguide coupled with one or more optical elements.

The IMU 440 is an electronic device that generates data indicating a position of the NED 405 based on measurement signals received from one or more of the position sensors 435 and from depth information received from the DCA 455. In some embodiments of the NED 405, the IMU 440 may be a dedicated hardware component. In other embodiments, the IMU 440 may be a software component implemented in one or more processors.

In operation, a position sensor 435 generates one or more measurement signals in response to a motion of the NED 405. Examples of position sensors 435 include: one or more accelerometers, one or more gyroscopes, one or more magnetometers, one or more altimeters, one or more inclinometers, and/or various types of sensors for motion detection, drift detection, and/or error detection. The position sensors 435 may be located external to the IMU 440, internal to the IMU 440, or some combination thereof.

Based on the one or more measurement signals from one or more position sensors 435, the IMU 440 generates data indicating an estimated current position of the NED 405 relative to an initial position of the NED 405. For example, the position sensors 435 include multiple accelerometers to measure translational motion (forward/back, up/down, left/right) and multiple gyroscopes to measure rotational motion (e.g., pitch, yaw, and roll). In some embodiments, the IMU 440 rapidly samples the measurement signals and calculates the estimated current position of the NED 405 from the sampled data. For example, the IMU 440 integrates the measurement signals received from the accelerometers over time to estimate a velocity vector and integrates the velocity vector over time to determine an estimated current position of a reference point on the NED 405. Alternatively, the IMU 440 provides the sampled measurement signals to the console 470, which analyzes the sample data to determine one or more measurement errors. The console 470 may further transmit one or more of control signals and/or measurement errors to the IMU 440 to configure the IMU 440 to correct and/or reduce one or more measurement errors (e.g., drift errors). The reference point is a point that may be used to describe the position of the NED 405. The reference point may generally be defined as a point in space or a position related to a position and/or orientation of the NED 405.

In various embodiments, the IMU 440 receives one or more parameters from the console 470. The one or more parameters are used to maintain tracking of the NED 405. Based on a received parameter, the IMU 440 may adjust one or more IMU parameters (e.g., a sample rate). In some embodiments, certain parameters cause the IMU 440 to update an initial position of the reference point so that it corresponds to a next position of the reference point. Updating the initial position of the reference point as the next calibrated position of the reference point helps reduce drift errors in detecting a current position estimate of the IMU 440.

In various embodiments, the eye tracking system 445 is integrated into the NED 405. The eye tracking system 445 may comprise one or more illumination sources (e.g., infrared illumination source, visible light illumination source) and one or more imaging devices (e.g., one or more cameras). In operation, the eye tracking system 445 generates and analyzes tracking data related to a user's eyes as the user wears the NED 405. In various embodiments, the eye tracking system 445 estimates the angular orientation of the user's eye. The orientation of the eye corresponds to the direction of the user's gaze within the NED 405. The orientation of the user's eye is defined herein as the direction of the foveal axis, which is the axis between the fovea (an area on the retina of the eye with the highest concentration of photoreceptors) and the center of the eye's pupil. In general, when a user's eyes are fixed on a point, the foveal axes of the user's eyes intersect that point. The pupillary axis is another axis of the eye that is defined as the axis passing through the center of the pupil and that is perpendicular to the corneal surface. The pupillary axis does not, in general, directly align with the foveal axis. Both axes intersect at the center of the pupil, but the orientation of the foveal axis is offset from the pupillary axis by approximately −1° to 6° laterally and +4° vertically. Because the foveal axis is defined according to the fovea, which is located in the back of the eye, the foveal axis can be difficult or impossible to detect directly in some eye tracking embodiments. Accordingly, in some embodiments, the orientation of the pupillary axis is detected and the foveal axis is estimated based on the detected pupillary axis.

In general, movement of an eye corresponds not only to an angular rotation of the eye, but also to a translation of the eye, a change in the torsion of the eye, and/or a change in shape of the eye. The eye tracking system 445 may also detect translation of the eye, i.e., a change in the position of the eye relative to the eye socket. In some embodiments, the translation of the eye is not detected directly, but is approximated based on a mapping from a detected angular orientation. Translation of the eye corresponding to a change in the eye's position relative to the detection components of the eye tracking unit may also be detected. Translation of this type may occur, for example, due to a shift in the position of the NED 405 on a user's head. The eye tracking system 445 may also detect the torsion of the eye, i.e., rotation of the eye about the pupillary axis. The eye tracking system 445 may use the detected torsion of the eye to estimate the orientation of the foveal axis from the pupillary axis. The eye tracking system 445 may also track a change in the shape of the eye, which may be approximated as a skew or scaling linear transform or a twisting distortion (e.g., due to torsional deformation). The eye tracking system 445 may estimate the foveal axis based on some combination of the angular orientation of the pupillary axis, the translation of the eye, the torsion of the eye, and the current shape of the eye.

As the orientation may be determined for both eyes of the user, the eye tracking system 445 is able to determine where the user is looking. The NED 405 can use the orientation of the eye to, e.g., determine an inter-pupillary distance (IPD) of the user, determine gaze direction, introduce depth cues (e.g., blur image outside of the user's main line of sight), collect heuristics on the user interaction in the VR media (e.g., time spent on any particular subject, object, or frame as a function of exposed stimuli), some other function that is based in part on the orientation of at least one of the user's eyes, or some combination thereof. Determining a direction of a user's gaze may include determining a point of convergence based on the determined orientations of the user's left and right eyes. A point of convergence may be the point that the two foveal axes of the user's eyes intersect (or the nearest point between the two axes). The direction of the user's gaze may be the direction of a line through the point of convergence and through the point halfway between the pupils of the user's eyes.

In some embodiments, the varifocal module 450 is integrated into the NED 405. The varifocal module 450 may be communicatively coupled to the eye tracking system 445 in order to enable the varifocal module 450 to receive eye tracking information from the eye tracking system 445. The varifocal module 450 may further modify the focus of image light emitted from the display 425 based on the eye tracking information received from the eye tracking system 445. Accordingly, the varifocal module 450 can reduce vergence-accommodation conflict that may be produced as the user's eyes resolve the image light. In various embodiments, the varifocal module 450 can be interfaced (e.g., either mechanically or electrically) with at least one optical element of the optical assembly 430.

In operation, the varifocal module 450 may adjust the position and/or orientation of one or more optical elements in the optical assembly 430 in order to adjust the focus of image light propagating through the optical assembly 430. In various embodiments, the varifocal module 450 may use eye tracking information obtained from the eye tracking system 445 to determine how to adjust one or more optical elements in the optical assembly 430. In some embodiments, the varifocal module 450 may perform foveated rendering of the image light based on the eye tracking information obtained from the eye tracking system 445 in order to adjust the resolution of the image light emitted by the display 425. In this case, the varifocal module 450 configures the display 425 to display a high pixel density in a foveal region of the user's eye-gaze and a low pixel density in other regions of the user's eye-gaze.

The I/O interface 475 facilitates the transfer of action requests from a user to the console 470. In addition, the I/O interface 475 facilitates the transfer of device feedback from the console 470 to the user. An action request is a request to perform a particular action. For example, an action request may be an instruction to start or end capture of image or video data or an instruction to perform a particular action within an application, such as pausing video playback, increasing or decreasing the volume of audio playback, and so forth. In various embodiments, the I/O interface 475 may include one or more input devices. Example input devices include: a keyboard, a mouse, a game controller, a joystick, and/or any other suitable device for receiving action requests and communicating the action requests to the console 470. In some embodiments, the I/O interface 475 includes an IMU 440 that captures calibration data indicating an estimated current position of the I/O interface 475 relative to an initial position of the I/O interface 475.

In operation, the I/O interface 475 receives action requests from the user and transmits those action requests to the console 470. Responsive to receiving the action request, the console 470 performs a corresponding action. For example, responsive to receiving an action request, console 470 may configure I/O interface 475 to emit haptic feedback onto an arm of the user. For example, console 470 may configure I/O interface 475 to deliver haptic feedback to a user when an action request is received. Additionally or alternatively, the console 470 may configure the I/O interface 475 to generate haptic feedback when the console 470 performs an action, responsive to receiving an action request.

The console 470 provides content to the NED 405 for processing in accordance with information received from one or more of: the DCA 455, the eye tracking system 445, one or more other components of the NED 405, and the I/O interface 475. In the embodiment shown in FIG. 6, the console 470 includes an application store 460 and an engine 465. In some embodiments, the console 470 may have additional, fewer, or different modules and/or components than those described in conjunction with FIG. 4. Similarly, the functions further described below may be distributed among components of the console 470 in a different manner than described in conjunction with FIG. 4.

The application store 460 stores one or more applications for execution by the console 470. An application is a group of instructions that, when executed by a processor, performs a particular set of functions, such as generating content for presentation to the user. For example, an application may generate content in response to receiving inputs from a user (e.g., via movement of the NED 405 as the user moves his/her head, via the I/O interface 475, etc.). Examples of applications include: gaming applications, conferencing applications, video playback applications, or other suitable applications.

In some embodiments, the engine 465 generates a three-dimensional mapping of the area surrounding the NED 405 (i.e., the “local area”) based on information received from the NED 405. In some embodiments, the engine 465 determines depth information for the three-dimensional mapping of the local area based on depth data received from the NED 405. In various embodiments, the engine 465 uses depth data received from the NED 405 to update a model of the local area and to generate and/or modify media content based in part on the updated model of the local area.

The engine 465 also executes applications within the NED system 400 and receives position information, acceleration information, velocity information, predicted future positions, or some combination thereof, of the NED 405. Based on the received information, the engine 465 determines various forms of media content to transmit to the NED 405 for presentation to the user. For example, if the received information indicates that the user has looked to the left, the engine 465 generates media content for the NED 405 that mirrors the user's movement in a virtual environment or in an environment augmenting the local area with additional media content. Accordingly, the engine 465 may generate and/or modify media content (e.g., visual and/or audio content) for presentation to the user. The engine 465 may further transmit the media content to the NED 405. Additionally, in response to receiving an action request from the I/O interface 475, the engine 465 may perform an action within an application executing on the console 470. The engine 465 may further provide feedback when the action is performed. For example, the engine 465 may configure the NED 405 to generate visual and/or audio feedback and/or the I/O interface 475 to generate haptic feedback to the user.

In some embodiments, based on the eye tracking information (e.g., orientation of the user's eye) received from the eye tracking system 445, the engine 465 determines a resolution of the media content provided to the NED 405 for presentation to the user on the display 425. The engine 465 may adjust a resolution of the visual content provided to the NED 405 by configuring the display 425 to perform foveated rendering of the visual content, based at least in part on a direction of the user's gaze received from the eye tracking system 445. The engine 465 provides the content to the NED 405 having a high resolution on the display 425 in a foveal region of the user's gaze and a low resolution in other regions, thereby reducing the power consumption of the NED 405. In addition, using foveated rendering reduces a number of computing cycles used in rendering visual content without compromising the quality of the user's visual experience. In some embodiments, the engine 465 can further use the eye tracking information to adjust a focus of the image light emitted from the display 425 in order to reduce vergence-accommodation conflicts.

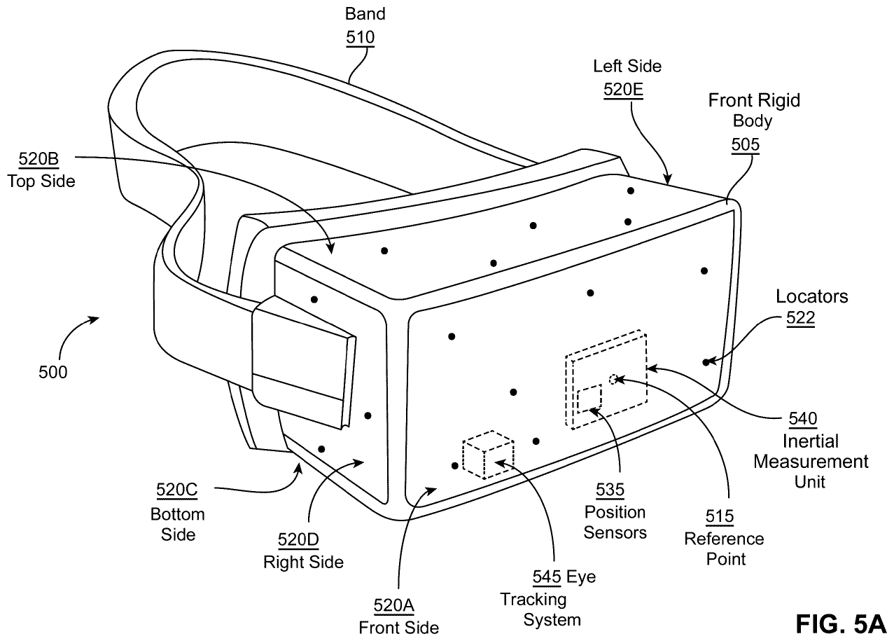

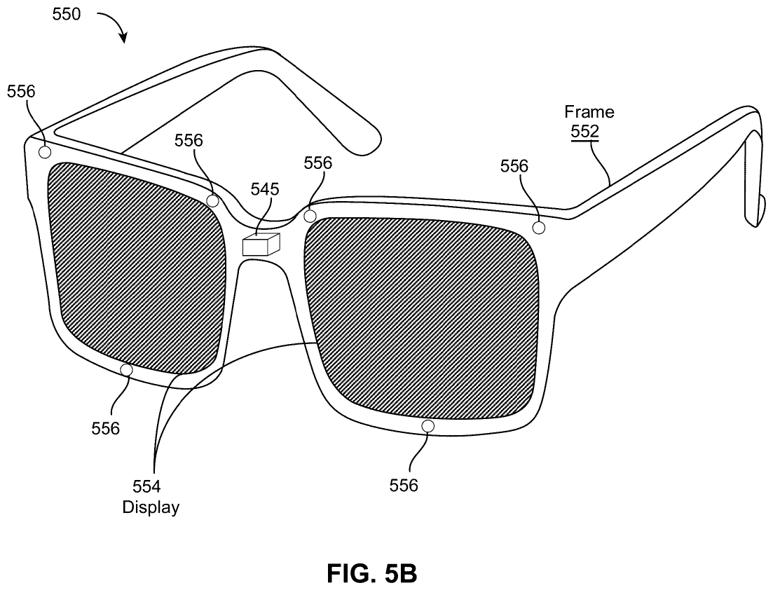

FIG. 5A is a diagram of an NED 500, according to various embodiments. In various embodiments, NED 500 presents media to a user. The media may include visual, auditory, and haptic content. In some embodiments, NED 500 provides artificial reality (e.g., virtual reality) content by providing a real-world environment and/or computer-generated content. In some embodiments, the computer-generated content may include visual, auditory, and haptic information. The NED 500 is an embodiment of the NED 405 and includes a front rigid body 505 and a band 510. The front rigid body 505 includes an electronic display element of the electronic display 425 (not shown in FIG. 5A), the optical assembly 430 (not shown in FIG. 5A), the IMU 540, the one or more position sensors 535, the eye tracking system 545, and the locators 522. In the embodiment shown by FIG. 5A, the position sensors 535 are located within the IMU 540, and neither the IMU 540 nor the position sensors 535 are visible to the user.

The locators 522 are located in fixed positions on the front rigid body 505 relative to one another and relative to a reference point 515. In the example of FIG. 5A, the reference point 515 is located at the center of the IMU 540. Each of the locators 522 emits light that is detectable by the imaging device in the DCA 455. The locators 522, or portions of the locators 522, are located on a front side 520A, a top side 520B, a bottom side 520C, a right side 520D, and a left side 520E of the front rigid body 505 in the example of FIG. 5A.

The NED 500 includes the eye tracking system 545. As discussed above, the eye tracking system 545 may include a structured light generator that projects an interferometric structured light pattern onto the user's eye and a camera to detect the illuminated portion of the eye. The structured light generator and the camera may be located off the axis of the user's gaze. In various embodiments, the eye tracking system 545 may include, additionally or alternatively, one or more time-of-flight sensors and/or one or more stereo depth sensors. In FIG. 5A, the eye tracking system 545 is located below the axis of the user's gaze, although the eye tracking system 545 can alternately be placed elsewhere. Also, in some embodiments, there is at least one eye tracking unit for the left eye of the user and at least one tracking unit for the right eye of the user.

In various embodiments, the eye tracking system 545 includes one or more cameras on the inside of the NED 500. The camera(s) of the eye tracking system 545 may be directed inwards, toward one or both eyes of the user while the user is wearing the NED 500, so that the camera(s) may image the eye(s) and eye region(s) of the user wearing the NED 500. The camera(s) may be located off the axis of the user's gaze. In some embodiments, the eye tracking system 545 includes separate cameras for the left eye and the right eye (e.g., one or more cameras directed toward the left eye of the user and, separately, one or more cameras directed toward the right eye of the user).

FIG. 5B is a diagram of an NED 550, according to various embodiments. In various embodiments, NED 550 presents media to a user. The media may include visual, auditory, and haptic content. In some embodiments, NED 550 provides artificial reality (e.g., augmented reality) content by providing a real-world environment and/or computer-generated content. In some embodiments, the computer-generated content may include visual, auditory, and haptic information. The NED 550 is an embodiment of the NED 405.

NED 550 includes frame 552 and display 554. In various embodiments, the NED 550 may include one or more additional elements. Display 554 may be positioned at different locations on the NED 550 than the locations illustrated in FIG. 5B. Display 554 is configured to provide content to the user, including audiovisual content. In some embodiments, one or more displays 554 may be located within frame 552.

NED 550 further includes eye tracking system 545 and one or more corresponding modules 556. The modules 556 may include emitters (e.g., light emitters) and/or sensors (e.g., image sensors, cameras). In various embodiments, the modules 556 are arranged at various positions along the inner surface of the frame 552, so that the modules 556 are facing the eyes of a user wearing the NED 550. For example, the modules 556 could include emitters that emit structured light patterns onto the eyes and image sensors to capture images of the structured light pattern on the eyes. As another example, the modules 556 could include multiple time-of-flight sensors for directing light at the eyes and measuring the time of travel of the light at each pixel of the sensors. As a further example, the modules 556 could include multiple stereo depth sensors for capturing images of the eyes from different vantage points. In various embodiments, the modules 556 also include image sensors for capturing 2D images of the eyes.

In operation, the view event logging system 120 receives and stores view events for various media players 110. A view event occurs when a field of view associated with a video being consumed via a media player 110 is modified. In various embodiments, the view event identifies one or more of the video being consumed, the media player 110 on which the video is being consumed, the view angle of the scene being viewed within the video, and frame information associated with the current frame being consumed. The view event logging system 120 logs the view events received from the various media players 110. When a threshold amount of view events for a given video are received, the view event logging system 120 transmits a notification to the interest evaluation system 130. The interest evaluation system 130 processes the view events associated with a given video to generate a heatmap for each frame of the video. The heatmap indicates, for a given frame, regions of interest in that frame as determined based on users' view angles. For a given frame, the interest evaluation system 130 divides the frame into tiles and, for each tile, determines a corresponding interest level based on the region in the heatmap that corresponds to the tile. The interest evaluation system 130 aggregates the interest levels for each frame into a region-based interest level representation associated with the video. The encoding system 140 generates a new encoded version of the video using the region-based interest level representation associated with the video. The new encoded version of the video can be transmitted to media players 110 in order to improve the viewing experience of the video.

One technical advantage of the disclosed techniques relative to the prior art is that the region-based interest level representation is a compressed representation of raw interest information associated with video content, enabling more efficient storage, transmission, and processing of the interest information. In particular, a downstream encoder receiving the region-based interest level can process and use the interest information during the encoding process much more efficiently relative to the raw interest information. Thus, using the region-based interest level representation enables encoders to more readily utilize interest-based encoding, thereby improving the performance of the encoding process and also of downstream delivery and consumption of the encoded videos. These technical advantages provide one or more technological improvements over prior art approaches.

1. In various embodiments, a computer-implemented method comprises identifying a plurality of view events associated with a frame of a video content, wherein each view event comprises field of view information indicating a region in the frame at which an interest of a given user was directed when the frame was being rendered, processing the field of view information included in at least a subset of the plurality of view events to generate per-pixel interest levels for a plurality of pixels in the frame, determining a plurality of regions in the frame including the plurality of pixels, generating per-region interest levels for the plurality of regions based on the per-pixel interest levels, and transmitting the per-region interest levels to one or more encoders for encoding the video content in a manner that accounts for the plurality of view events.

2. The computer-implemented method of clause 1, wherein the per-region interest levels are represented as a vector of interest levels associated with a timestamp corresponding to the frame, wherein a position of an interest level in the vector corresponds to a position of a region in the plurality of regions within the frame.

3. The computer-implemented method of clauses 1 or 2, wherein determining the plurality of regions comprises dividing the frame into a plurality of equal-sized tiles, wherein each tile corresponds to a different region in the plurality of regions.

4. The computer-implemented method of any of clauses 1-3, further comprising performing the steps of identifying, processing, determining, generating, and transmitting for each frame in the video content.

5. The computer-implemented method of any of clauses 1-4, wherein identifying the plurality of view events associated with the frame comprises determining that each of the view events comprises a timestamp corresponding to the frame.

6. The computer-implemented method of any of clauses 1-5, further comprising determining that a number of view events associated with the video content has exceeded a threshold, wherein the threshold indicates a certain number of view events needed to determine which regions in the video content are of interest to consumers of the video content.

7. The computer-implemented method of any of clauses 1-6, wherein the threshold changes as the amount of consumption of the video content changes.

8. The computer-implemented method of any of clauses 1-7, further comprising receiving a first view event of the plurality of view events from a first media player on which the video content is being rendered.

9. The computer-implemented method of any of clauses 1-8, further comprising transmitting an encoded version of the video content generated by the one or more encoders in response to receiving the per-region interest levels to one or more video players.

10. In various embodiments, one or more non-transitory computer-readable media store instructions that, when executed by one or more processors, cause the one or more processors to perform the steps of identifying a plurality of view events associated with a frame of a video content, wherein each view event comprises field of view information indicating a region in the frame at which an interest of a given user was directed when the frame was being rendered, processing the field of view information included in at least a subset of the plurality of view events to generate per-pixel interest levels for a plurality of pixels in the frame, determining a plurality of regions in the frame including the plurality of pixels, generating per-region interest levels for the plurality of regions based on the per-pixel interest levels, and transmitting the per-region interest levels to one or more encoders for encoding the video content in a manner that accounts for the plurality of view events.

11. The one or more non-transitory computer-readable media of clause 10, wherein the per-region interest levels are represented as a vector of interest levels associated with a timestamp corresponding to the frame, wherein a position of an interest level in the vector corresponds to a position of a region in the plurality of regions within the frame.

12. The one or more non-transitory computer-readable media of clause 10 or 11, wherein determining the plurality of regions comprises dividing the frame into a plurality of equal-sized tiles, wherein each tile corresponds to a different region in the plurality of regions.

13. The one or more non-transitory computer-readable media of any of clauses 10-12, further comprising performing the steps of identifying, processing, determining, generating, and transmitting for each frame in the video content.

14. The one or more non-transitory computer-readable media of any of clauses 10-13, wherein identifying the plurality of view events associated with the frame comprises determining that each of the view events comprises a timestamp corresponding to the frame.

15. The one or more non-transitory computer-readable media of any of clauses 10-14, further comprising determining that a number of view events associated with the video content has exceeded a threshold, wherein the threshold indicates a certain number of view events needed to determine which regions in the video content are of interest to consumers of the video content.

16. The one or more non-transitory computer-readable media of of any of clauses 10-15, wherein the threshold changes as the amount of consumption of the video content changes.

17. The one or more non-transitory computer-readable media of any of clauses 10-16, further comprising receiving a first view event of the plurality of view events from a first media player on which the video content is being rendered.

18. The one or more non-transitory computer-readable media of any of clauses 10-17, further comprising transmitting an encoded version of the video content generated by the one or more encoders in response to receiving the per-region interest levels to one or more video players.

19. A system, comprising one or more memories that store instructions, and one or more processors that are coupled to the one or more memories and, when executing the instructions, are configured to perform the steps of identifying a plurality of view events associated with a frame of a video content, wherein each view event comprises field of view information indicating a region in the frame at which an interest of a given user was directed when the frame was being rendered, processing the field of view information included in at least a subset of the plurality of view events to generate per-pixel interest levels for a plurality of pixels in the frame, determining a plurality of regions in the frame including the plurality of pixels, generating per-region interest levels for the plurality of regions based on the per-pixel interest levels, and transmitting the per-region interest levels to one or more encoders for encoding the video content in a manner that accounts for the plurality of view events.

20. The system of clause 19, wherein the per-region interest levels are represented as a vector of interest levels associated with a timestamp corresponding to the frame, wherein a position of an interest level in the vector corresponds to a position of a region in the plurality of regions within the frame.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method, the method comprising:
identifying a plurality of view events associated with a frame of a video content, wherein each view event comprises field of view information indicating a region in the frame at which an interest of a given user was directed when the frame was being rendered;
processing the field of view information included in at least a subset of the plurality of view events to generate per-pixel interest levels for a plurality of pixels in the frame;
determining a plurality of regions in the frame including the plurality of pixels;
generating per-region interest levels for the plurality of regions based on the per-pixel interest levels; and
transmitting the per-region interest levels to one or more encoders for encoding the video content in a manner that accounts for the plurality of view events.

2. The computer-implemented method of claim 1, wherein the per-region interest levels are represented as a vector of interest levels associated with a timestamp corresponding to the frame, wherein a position of an interest level in the vector corresponds to a position of a region in the plurality of regions within the frame.

3. The computer-implemented method of claim 1, wherein determining the plurality of regions comprises dividing the frame into a plurality of equal-sized tiles, wherein each tile corresponds to a different region in the plurality of regions.

4. The computer-implemented method of claim 1, further comprising performing the steps of identifying, processing, determining, generating, and transmitting for each frame in the video content.

5. The computer-implemented method of claim 1, wherein identifying the plurality of view events associated with the frame comprises determining that each of the view events comprises a timestamp corresponding to the frame.

6. The computer-implemented method of claim 1, further comprising determining that a number of view events associated with the video content has exceeded a threshold, wherein the threshold indicates a certain number of view events needed to determine which regions in the video content are of interest to consumers of the video content.

7. The computer-implemented method of claim 6, wherein the threshold changes as the amount of consumption of the video content changes.

8. The computer-implemented method of claim 1, further comprising receiving a first view event of the plurality of view events from a first media player on which the video content is being rendered.

9. The computer-implemented method of claim 1, further comprising transmitting an encoded version of the video content generated by the one or more encoders in response to receiving the per-region interest levels to one or more video players.

10. One or more non-transitory computer-readable media storing instructions that, when executed by one or more processors, cause the one or more processors to perform the steps of:
identifying a plurality of view events associated with a frame of a video content, wherein each view event comprises field of view information indicating a region in the frame at which an interest of a given user was directed when the frame was being rendered;
processing the field of view information included in at least a subset of the plurality of view events to generate per-pixel interest levels for a plurality of pixels in the frame;
determining a plurality of regions in the frame including the plurality of pixels;
generating per-region interest levels for the plurality of regions based on the per-pixel interest levels; and
transmitting the per-region interest levels to one or more encoders for encoding the video content in a manner that accounts for the plurality of view events.

11. The one or more non-transitory computer-readable media of claim 10, wherein the per-region interest levels are represented as a vector of interest levels associated with a timestamp corresponding to the frame, wherein a position of an interest level in the vector corresponds to a position of a region in the plurality of regions within the frame.

12. The one or more non-transitory computer-readable media of claim 10, wherein determining the plurality of regions comprises dividing the frame into a plurality of equal-sized tiles, wherein each tile corresponds to a different region in the plurality of regions.

13. The one or more non-transitory computer-readable media of claim 10, further comprising performing the steps of identifying, processing, determining, generating, and transmitting for each frame in the video content.

14. The one or more non-transitory computer-readable media of claim 10, wherein identifying the plurality of view events associated with the frame comprises determining that each of the view events comprises a timestamp corresponding to the frame.

15. The one or more non-transitory computer-readable media of claim 10, further comprising determining that a number of view events associated with the video content has exceeded a threshold, wherein the threshold indicates a certain number of view events needed to determine which regions in the video content are of interest to consumers of the video content.

16. The one or more non-transitory computer-readable media of claim 15, wherein the threshold changes as the amount of consumption of the video content changes.

17. The one or more non-transitory computer-readable media of claim 10, further comprising receiving a first view event of the plurality of view events from a first media player on which the video content is being rendered.

18. The one or more non-transitory computer-readable media of claim 10, further comprising transmitting an encoded version of the video content generated by the one or more encoders in response to receiving the per-region interest levels to one or more video players.

19. A system, comprising:
one or more memories that store instructions, and
one or more processors that are coupled to the one or more memories and,
when executing the instructions, are configured to perform the steps of:
identifying a plurality of view events associated with a frame of a video content, wherein each view event comprises field of view information indicating a region in the frame at which an interest of a given user was directed when the frame was being rendered;
processing the field of view information included in at least a subset of the plurality of view events to generate per-pixel interest levels for a plurality of pixels in the frame;
determining a plurality of regions in the frame including the plurality of pixels;
generating per-region interest levels for the plurality of regions based on the per-pixel interest levels; and
transmitting the per-region interest levels to one or more encoders for encoding the video content in a manner that accounts for the plurality of view events.

20. The system of claim 19, wherein the per-region interest levels are represented as a vector of interest levels associated with a timestamp corresponding to the frame, wherein a position of an interest level in the vector corresponds to a position of a region in the plurality of regions within the frame.
